(19) United States
(12) Patent Application Publication
(10) Pub. No.: US 2004/0179364 A1
(43) Pub. Date: Sep. 16, 2004

(54) Array for reducing the coherence of a coherent radiation beam

(76) Inventors: Matthias Burkhardt, Eichenberg (DE); Rainhard Steiner, Stradtroda (DE); Alexander Menck, Jena (DE); Lars Erdmann, Horselgau (DE); Jorg BIschoff, Ilmenau (DE)

Correspondence Address: Douglas J Christensen, Patterson Thuente Skaar & Christensen, 4800 IDS Center, 80 South Eighth Street, Minneapolis, MN, 55402, US

(21) Appl. No.: 10/472,169

(22) PCT Filed: Sep. 18, 2002
(86) PCT No.: PCT/EP02/10475

(30) Foreign Application Priority Data
Sep. 28, 2001 (DE) 101 48 162.4

(51) Int. Cl. F21V 7/00

(52) U.S. Cl. 362/298; 362/301; 362/328

(57) ABSTRACT

The invention relates to an array for reducing the coherence of a coherent radiation beam (6), wherein a reflector (1) defining an inner space is provided with a diffusely reflecting inner surface (4), wherein said reflector (1) has an inlet hole (2) through which the radiation beam (6) can be injected into the inner space, in addition to an outlet hole (3) through which the rays of the radiation beam (6) can come out after at least one reflection on the inner surface (4).

The invention relates to an arrangement for reducing the coherence of a coherent beam. Such an arrangement is used, for example, to generate a homogeneously illuminated object field in a microscope, since the coherence of the beam may cause undesired interference phenomena and speckle in the object field. These effects have the disadvantage that they lead to a marked deterioration of the homogeneity of the illuminated object field.

Therefore, scattering elements, such as diffusing screens, which generate different and, preferably, statistically distributed phase shifts in the beam, are introduced into the optical path, thus reducing the spatial coherence of the beam. In order to reduce coherence as much as possible, the scattering elements should scatter the individual rays of the beam in as many different directions as possible. However, this causes the initial parallelism of the beam to be eliminated, which makes it practically impossible to collimate the scattered rays again. Therefore, only a small part of the total scattered radiation can be employed for the desired homogeneous illumination of the object field, so that great losses occur and a very powerful source of radiation is required for a given brightness of said illumination. This has the disadvantage of causing high costs of acquisition and operation.

In view thereof, it is an object of the invention to provide an arrangement for reducing the coherence of a coherent beam allowing to effectively reduce said coherence and to generate a beam of reduced coherence.

According to the invention, the object is achieved by an arrangement for reducing the coherence of a coherent beam, wherein a reflector limiting an interior space and having a diffusely reflecting internal surface is provided, said reflector comprising an inlet opening, through which the beam may be coupled into the interior space, as well as an outlet opening, through which rays of said beam exit after being reflected at least once by the internal surface.

By providing the reflector with the internal surface limiting the interior space an interactive region forming a closed space is provided, wherein rays of the coupled-in beam are diffusely reflected at least once, and preferably several times, before exiting said interior space again through the outlet opening. These output rays form a beam whose coherence is clearly reduced as compared to that of the coupled-in beam.

Since the interactive region is a closed space and the beam can be coupled out with reduced coherence only via the outlet opening, the coupled-out beam contains rays which have been reflected in the reflector at the most diverse angles and which are united to form the coupled-out beam only because they all pass through the outlet opening. Therefore, the reduction in coherence of the arrangement according to the invention is extremely effective, and at the same time, a very large part of the coupled-in beam may also be used further as an output beam of reduced coherence. This leads to the advantage that a clearly less powerful source of radiation may be used to effect illumination of an object field with a predetermined brightness.

Also, advantageously, the light conduction value (which is proportional to the product of the beam cross-section with the angle of aperture of the beam) of the beam of reduced coherence may be kept below a certain value by the arrangement according to the invention, although a large number of reflections of the rays exiting through the outlet opening is present. The light conduction value of the coupled-out beam may be influenced, for example, by the size of the outlet opening, said light conduction value itself decreasing as the size of the outlet opening is reduced.

The inlet and outlet openings are preferably circular or angular (e.g. quadrangular or rectangular) and preferably have a diameter (or a diagonal dimension) of less than 1 mm, so that the size of the opening is less than 1 square millimeter.

As used herein, a diffusely reflecting surface means a surface by which the individual rays of the beam impinging on said surface are reflected in different directions. Such reflection may occur by means of a reflection according to the law of reflection, by refraction, diffraction or other effects. It is essential that the rays impinging on the internal surface be reflected by the internal surface and not transmitted.

The diffusely reflecting surface may be provided, for example, by an optically rough reflecting layer which comprises a structure having a spatial modulation equal to or greater than the wavelength of the coherent beam.

Since the coherent beam is reflected to cause the reduction in coherence, there are no undesired effects of dispersion. Also, the use of refractive elements can be avoided, which is a great advantage, in particular, for short-wavelength radiation (less than 250 nm). Thus, for a radiation at 157 nm, there is practically only calcium fluoride available as the material for preparing refractive elements. However, calcium fluoride is very expensive and difficult to process. Further, reflection for the purpose of coherence reduction also avoids the undesired absorption losses of the radiation which would occur when using refractive elements.

In an advantageous embodiment of the arrangement according to the invention, the inlet and outlet openings are realized by the same opening. Thus, in this case, the reflector is required to have only one opening so that (nearly) the entire output radiation may be utilized as a beam of reduced coherence.

Further, in the arrangement according to the invention, a second reflector comprising a diffusely reflecting portion may be arranged in the interior space such that the coupled-in beam impinges on said portion. Advantageously, this has the effect that the rays exiting from the outlet opening have been diffusely reflected at least twice, thus achieving an improved reduction in coherence.

The average number of reflections in the reflector may be adjusted by the ratio of the surface area of the reflecting internal surface to the surface area of the outlet opening such that, the higher this ratio is, the more reflections will take place. In practice, the average number of reflections will be adjusted depending on the desired reduction in coherence and the desired radiant flux of the output beam, since each reflection will also involve certain losses (for example, by absorption).

The interior space of the reflector in the arrangement according to the invention may be filled, in particular, with a gaseous medium. In doing so, the gaseous medium is preferably selected such that it has the highest possible transmission for the beam and, if desired, also has a passivating effect on the diffusely reflecting internal surface. If the internal surface is formed, for example, by an aluminum coating, the undesired oxidation of the aluminum surface may be passivated, in particular, for beams having a wavelength in the range of about 200 nm, by using nitrogen gas.

Alternatively, it is also possible to provide a passivating layer on the internal surface. When using aluminum as the reflecting internal surface, use may be made of an SiO₂ coating as the passivating or protective layer. In doing so, said aluminum coating may be, for example, either vapor-deposited or sputtered, and the SiO₂ protecting layer may also be sputtered onto the aluminum coating.

An advantageous further embodiment of the arrangement according to the invention consists in that the interior space of the reflector is provided as a solid body, in which case the internal surface may be realized by a coating layer of the external surface of the solid body. Said coating layer, in turn, may consist of aluminum, for example. Thus, in this case, the optically active side of the coating layer faces the solid body or is in direct contact with it, so that a passivation or protection of the coating layer is already achieved thereby. Accordingly, it is no longer required to provide a separate passivating layer.

For example, the reflector may have a spherical, parallelepiped, cylindrical or cube shape, its spatial expansion preferably being greater than the coherence length in time of the beam and the reflector having an interior space of not more than a few cubic centimeters, for example. In this case, the coherence length in time of the beam is the coherence length in the propagation direction of the beam. In particular, in multimode lasers, such as excimer lasers emitting what is called partially coherent radiation, the coherence length in time may be comparatively small, so that this requirement concerning the expansion of the reflector is easy to realize. Thus, for example, an argon/fluoride excimer laser emits a beam having a wavelength of about 193 nm and a coherence length in time of about 100 μm. The coherence length in time is understood to be a minimum (preferably the first minimum) of the coherence function in time. Thus, the interference contrast upon superposition of two beams being phase-shifted by the coherence length in time is minimal. In the argon/fluoride excimer laser, said minimum is at about 100 μm.

Further, the arrangement may also comprise a source of radiation emitting the coherent beam. Said source of radiation may be a laser (e.g. an excimer laser) and may emit radiation having a wavelength of less than 250 nm or lying in the UV range or in the deep UV range.

The diameter of the outlet and inlet openings is preferably in the submillimeter range and may be ¼-½ mm. Further, the outlet opening is preferably larger than the inlet opening, allowing to minimize the losses caused by radiation exiting via the inlet opening.

Further, the reflector may comprise only the inlet and outlet openings and is otherwise completely closed. This also reduces losses due to undesirably exiting radiation.

In a preferred embodiment of the arrangement according to the invention, a focussing device is provided which focusses the beam into the inlet opening or into the interior space. This allows the inlet opening to be kept very small, thus reducing the losses caused by radiation exiting through the inlet opening.

The invention will be explained in more detail below, by way of example and with reference to the drawings, wherein:

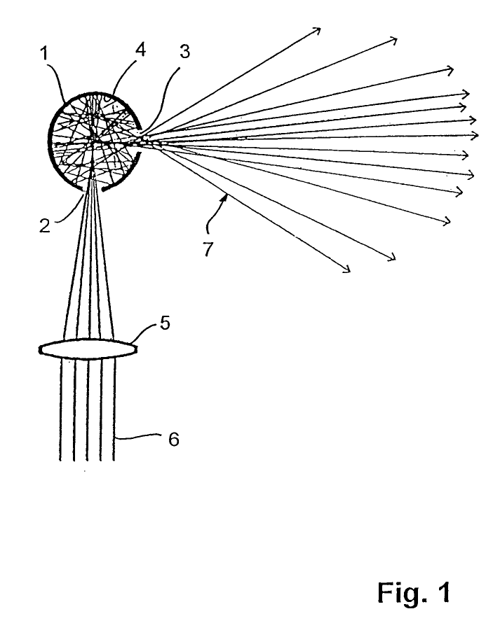

FIG. 1 schematically shows a first embodiment of the arrangement for reducing the coherence of a coherent beam;

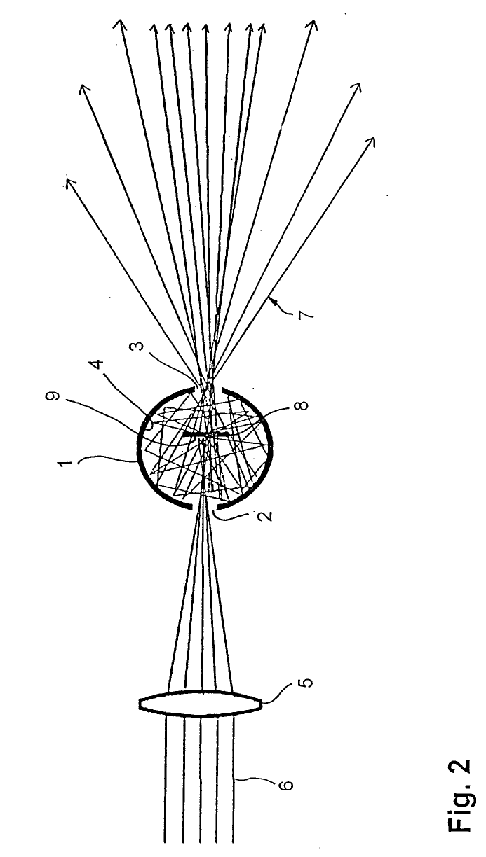

FIG. 2 schematically shows a second embodiment of the arrangement for reducing the coherence of a coherent beam, and

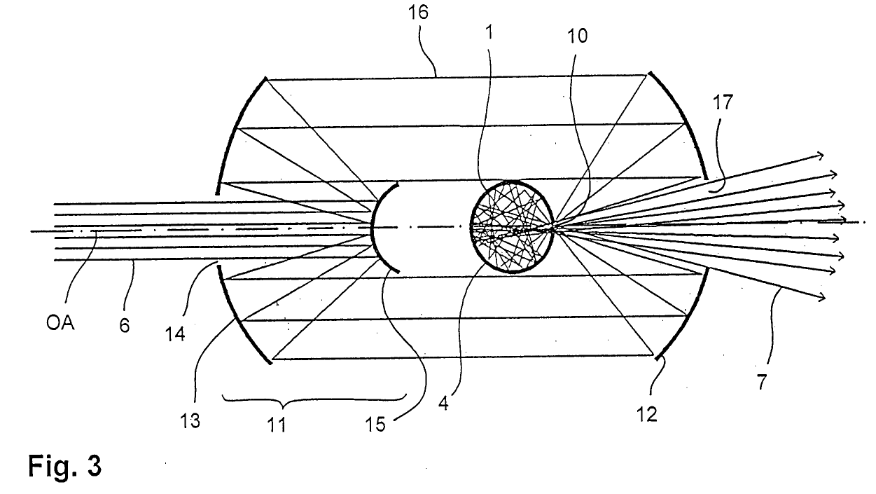

FIG. 3 schematically shows a third embodiment of the arrangement for reducing the coherence of a coherent beam.

As shown in FIG. 1, the arrangement according to the invention for reducing the coherence of a coherent beam comprises a hollow sphere-shaped reflector 1 having inlet and outlet openings 2, 3, with the outlet opening 3 shown in FIG. 1 being arranged at a position offset by 90° relative to the inlet opening 2.

The internal surface 4 of the reflector 1 limits the hollow interior space and is provided as a diffusely reflecting surface which, for example, may consist of aluminum, vapor-deposited or sputtered onto the internal surface of the reflector 1. In doing so, either the conditions during vapor-depositing or during sputtering may be selected such that the layer formed thereby is structured so as to have a diffusely reflecting effect, or the internal surface may already comprise the corresponding structure. In this case, the structure of the thus formed internal surface 4 is selected such that the internal surface 4 is optically rough for the radiation of the beam, which means, in this case, that the spatial modulation of the structure is within, or greater than, the wavelength range.

Further, the arrangement according to the invention also comprises a lens 5, which serves to focus a coherent, parallel beam 6 (emitted by a source of radiation which is not shown) into the reflector 1. Said focussing advantageously allows the entire beam 6 to be coupled into the reflector, and it is possible to make the size of the inlet opening 2 as small as possible. This minimizes, as much as possible, the losses caused by the rays exiting again through the inlet opening 2.

Each beam exiting again through the outlet opening 3 is reflected at least once in the reflector 1 (by way of example, FIG. 1 shows only the optical path for rays exiting again through the outlet opening 3). Together, all exiting rays form an output beam 7, whose coherence is greatly reduced as compared to the coherence of the coupled-in beam 6, because of the individual rays having traveled different optical path lengths due to the diffuse reflection. Thus, a reduction in spatial coherence is achieved. In other words, incoherent mixing occurs due to said reflections in the reflector 1, thus reducing the coherence of the output beam 7.

FIG. 2 shows a second embodiment wherein the reflector 1 is formed such that the rays of the output beam 7 have been reflected at least twice in the reflector 1.

The reflector 1 is, again, provided in the shape of a hollow sphere, with the inlet and outlet openings, however, facing each other. The internal surface 4 of the hollow sphere-shaped reflector 1 is formed in the same manner as in the first embodiment. A second reflector 8, which is plate-shaped and whose external surfaces reflect diffusely, is arranged in the reflector 1. As is evident from FIG. 2, the second reflector 8 is arranged between the inlet and outlet openings 2, 3 in such a manner that it intersects a connecting line from the inlet opening 2 to the outlet opening 3 and prevents the direct passage of the rays from the inlet opening to the outlet opening 3. Thus, the second reflector 8 acts as a stop, shading the outlet opening 3 against the inlet opening 2. As a result, the coupled-in beam 6 first impinges on and is diffusely reflected by the side 9 of the second reflector 8 facing the inlet opening 2 . Before the rays can exit the reflector 1 through the outlet opening 3, they have to be reflected at least one more time by the internal surface 4 of the reflector 1, so that each exiting ray of the beam 7 has been reflected at least twice. This advantageously enhances the reduction in coherence, so that the coherence of the output beam 7 is even smaller than in the embodiment shown in FIG. 1.

FIG. 3 shows a third embodiment of the coherence-reducing arrangement according to the invention, in which embodiment the inlet and outlet openings are realized by one single opening 10 in the hollow sphere-shaped reflector 1. In the same manner as in the previous embodiments, the internal surface 4 of the hollow sphere-shaped reflector 1 is provided in a diffusely reflecting manner.

In order to couple the beam 6 into the reflector 1, the beam 6 is first expanded using an expansion device 11 and is then coupled into the reflector 1 via a coupling-in mirror 12.

The expansion device comprises a first concave mirror 13, which has a central passage opening 14 adapted to the beam cross-section of the beam 6 such that the entire beam 6 may pass through the opening 14. Further, the expansion device 11 comprises a convex mirror 15, which is arranged at a predetermined distance from the first concave mirror 13 and faces the latter. The beam 6 passes through the passage opening 14 of the first concave mirror 13 and impinges on the convex mirror 15 arranged behind it, by which it is reflected to the first concave mirror 13. The first concave mirror 13 reflects the rays coming from the convex mirror 15 such that an expanded, parallel beam 16 having an annular cross-section is formed, the circular center region of the cross-section preferably having the same diameter as the external diameter of the reflector 1. The expanded beam 16 impinges on the concave coupling-in mirror 12, by which it is reflected to the opening 10, so that the beam 6 is coupled into the reflector 1.

The coupling-in mirror 12 comprises a central outlet opening 17, through which the beam 7 exiting from the opening 10 passes so that the beam 7 is present with said reduced coherence following the coupling-in mirror 12.

As shown in FIG. 3, the mirrors 12, 13 and 15, and also the reflector 1, are arranged symmetrically to the optical axis OA.

1. An arrangement for reducing the coherence of a coherent beam (6), wherein said arrangement comprises a reflector (1) limiting an interior space and having a diffusely reflecting internal surface (4), said reflector (1) comprising an inlet opening (2), through which the beam (6) may be coupled into the interior space, as well as an outlet opening (3), through which rays of said beam (6) exit after being reflected at least once by the internal surface (4).

2. The arrangement as claimed in claim 1, wherein the outlet opening (3) is larger than the inlet opening (2).

3. The arrangement as claimed in claim 1, wherein the inlet and outlet openings (2, 3) are realized by the same opening (10).

4. The arrangement as claimed in any one of claims 1 to 3, wherein a second reflector (8) comprising a diffusely reflecting portion (9) is arranged in the interior space such that the coupled-in beam (6) impinges on said portion (9).

5. The arrangement as claimed in any one of claims 1 to 4, wherein the diffusely reflecting internal surface (4) is provided with a protective coating.

6. The arrangement as claimed in any one of claims 1 to 5, wherein the interior space is filled with a gaseous medium.

7. The arrangement as claimed in any one of claims 1 to 5, wherein the interior space is provided as a solid body.

8. The arrangement as claimed in any one of claims 1 to 7, wherein a focussing device (5; 11, 12), by which the beam (6) is focussed into the interior space, is arranged preceding the inlet opening (2).

9. The arrangement as claimed in any one of claims 1 to 8, wherein the reflector (1) is provided in the shape of a hollow sphere.

10. The arrangement as claimed in any one of claims 1 to 9, wherein the outlet opening (3) is larger than the inlet opening (2).
